(19) United States
(12) Patent Application Publication
(10) Pub. No.: US 2018/0163600 A1
(43) Pub. Date: Jun. 14, 2018

(54) COMPACT HYDROCARBON DOSING AND MIXING SYSTEM AND METHOD

(71) Applicant: Caterpillar Inc., Peoria, IL (US)

(72) Inventors: Edward L. KANE, Peoria, IL (US); John L. CLIFFORD, Lacon, IL (US); Swapnil PADATE, Peoria, IL (US)

(73) Assignee: Caterpillar Inc., Peoria, IL (US)

(21) Appl. No.: 15/377,555

(22) Filed: Dec. 13, 2016

(51) Int. Cl. F01N 3/28; F02B 37/00; F02B 37/007; F02B 37/18; F01N 3/36

(52) U.S. Cl. CPC F01N 3/2892; F02B 37/001; F01N 3/36; F02B 37/183; F02B 37/007

(57) ABSTRACT

A system to dose and mix hydrocarbon is disclosed, which includes a twin-parallel turbocharger equipped engine, a mixer coupled to exhaust outlets of the turbines of the twin-parallel turbocharger equipped engine, and a hydrocarbon dosing unit coupled to the mixer. A method of manufacturing the compact hydrocarbon dosing and mixing system is also disclosed, as is a method of dosing and mixing hydrocarbon.

### TECHNICAL FIELD

The present disclosure relates to after-treatment systems, and more particularly to a compact hydrocarbon dosing and mixing system, and a method of manufacturing the compact hydrocarbon dosing and mixing system.

### BACKGROUND

With the advancement of technology, machines having engines include an after-treatment system for treatment of exhaust gases coming from the engine. The after-treatment system usually includes an injection device, a catalytic device, and a particulate matter filter for treating the exhaust gases for harmful emissions. The injection device may inject hydrocarbons in the exhaust gases flowing towards the catalytic device and the particulate matter filter. The injection of the hydrocarbons may increase a temperature of the exhaust gases by oxidation of the hydrocarbons across the catalytic device.

It is relevant to ensure that the hydrocarbons injected into the exhaust gases evaporate before entering the catalytic device. In order to ensure the vaporization of the hydrocarbons, the injection unit should be disposed at a suitable distance from the catalytic device so that the hydrocarbons get enough time for vaporization before reaching an inlet of the catalytic device. Accommodating the suitable distance between the injection device and the catalytic device can result in a large size of the after-treatment system. The large size of the after-treatment system can lead to inconvenience with regard to handling, maintenance, installation, and uninstallation of the after-treatment system.

Japanese Patent No. 2007-315339 (hereinafter the '339 patent), shows an exhaust emission control system. In the exhaust emission control system of the '339 patent, an exhaust pipe is provided in which a branched exhaust pipe section having a turbine of a main turbo-supercharger and a branched exhaust pipe section having a turbine of a sub turbo-supercharger merge at a merged part. An exhaust switch valve opening and closing the branched exhaust pipe is also provided, wherein the internal combustion engine may close the exhaust switch valve in a prescribed operating area to prevent a flow of exhaust gas into the merged part through the branched exhaust pipe. A regenerative exhaust emission control unit and a fuel adding valve are also provided. The fuel adding valve is provided at the merged part so that the high-speed exhaust gas can hit against a periphery of an injection port when opening of the exhaust switch valve is small and flow speed of the exhaust gas passing through the exhaust switch valve is high.

### SUMMARY OF THE DISCLOSURE

In one aspect of the present disclosure, a system is disclosed. The system includes a twin-parallel turbocharger equipped engine, a mixer coupled to exhaust outlets of the turbines of the twin-parallel turbocharger equipped engine, and a hydrocarbon dosing unit coupled to the mixer.

In another aspect of the present disclosure, a system is disclosed. The system includes a twin-parallel turbocharger equipped engine, a mixer coupled directly to exhaust outlets of the turbines of the twin-parallel turbocharger equipped engine, and a hydrocarbon dosing unit coupled to the mixer. The system further includes a diesel oxidation catalyst that receives an exhaust stream output from the mixer; and control circuitry that controls operations of the hydrocarbon dosing unit.

In yet another aspect of the present disclosure, a method of manufacturing a system is disclosed. The method includes forming a twin-parallel turbocharger equipped engine. The method includes coupling a mixer to exhaust outlets of the turbines of the twin-parallel turbocharger equipped engine. The method further includes coupling a hydrocarbon dosing unit to the mixer.

Other features and aspects of this disclosure will be apparent from the following description and the accompanying drawings.

### BRIEF DESCRIPTION OF THE DRAWINGS

The accompanying drawings, which are incorporated in and constitute a part of the specification, are illustrative of one or more embodiments and, together with the description, explain the embodiments. The accompanying drawings have not necessarily been drawn to scale. Further, any values or dimensions in the accompanying drawings are for illustration purposes only and may or may not represent actual or preferred values or dimensions. Where applicable, some or all select features may not be illustrated to assist in the description and understanding of underlying features.

FIG. 1 is a schematic view of a compact hydrocarbon dosing and mixing system, according to one or more embodiments of the present disclosure;

FIG. 2 is an enlarged view of turbochargers, a mixer, and a hydrocarbon dosing unit of the compact hydrocarbon dosing and mixing system, according to one or more embodiments of the present disclosure;

FIG. 3 is a perspective view of the compact hydrocarbon dosing and mixing system, according to one or more embodiments of the present disclosure;

FIG. 4 is a cross-sectional view of the compact hydrocarbon dosing and mixing system, according to one or more embodiments of the present disclosure;

FIG. 5 is a schematic view of the compact hydrocarbon dosing and mixing system having electronic wastegates, according to one or more embodiments of the present disclosure;

FIG. 6 is a schematic view of the compact hydrocarbon dosing and mixing system having variable geometry turbines, according to one or more embodiments of the present disclosure; and

FIG. 7 is a flowchart for a method of manufacturing the compact hydrocarbon dosing and mixing system, according to one or more embodiments of the present disclosure.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, corresponding or similar reference numbers will be used throughout the drawings to refer to the same or corresponding parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural references unless the context clearly dictates otherwise. That is, unless clearly specified otherwise, as used herein the words “a” and “an” and the like carry the meaning of “one or more.” Additionally, it is to be understood that terms such as “left,” “right,” “up,” “down,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Generally speaking, embodiments of the present disclosure can provide a system and a method to dose and/or mix hydrocarbons. The system includes a twin-parallel turbocharger equipped engine, a mixer coupled to exhaust outlets of the turbines of the twin-parallel turbocharger equipped engine, and a hydrocarbon dosing unit coupled to the mixer. The twin-parallel turbocharger equipped engine, the mixer, and the hydrocarbon dosing unit are disposed in a manner to cause a reduction in size of an after-treatment system and therefore, compacting the system.

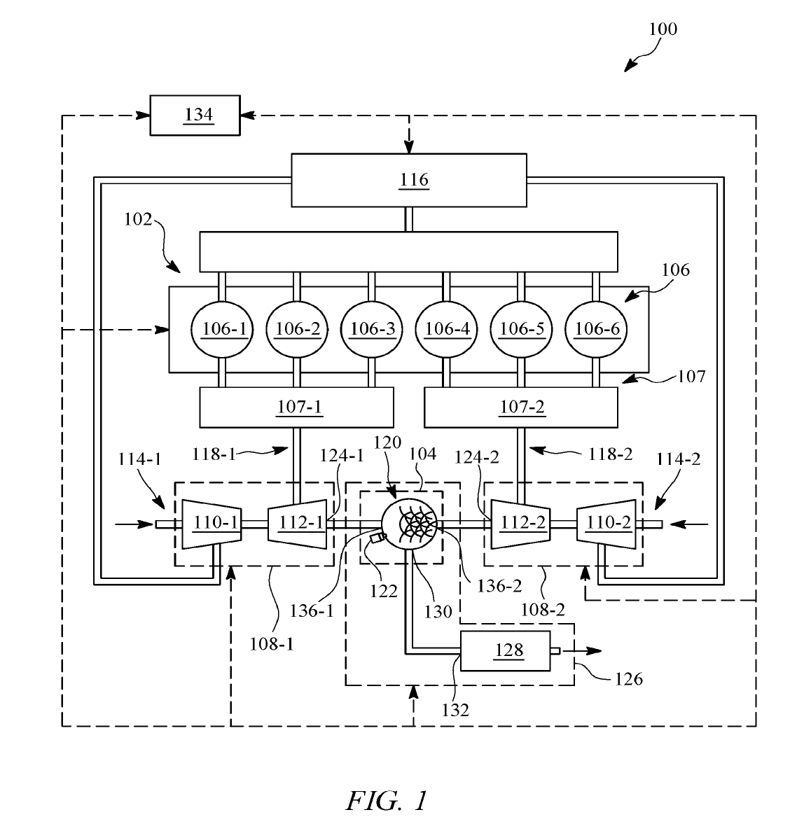

FIG. 1 illustrates a schematic view of a system 100, according to one or more embodiments of the present disclosure. The system 100 is hereinafter referred to as “compact hydrocarbon dosing and mixing system 100” or “hydrocarbon dosing and mixing system 100”. The compact hydrocarbon dosing and mixing system 100 may include a twin-parallel turbocharger equipped engine 102 and a dosing and mixing unit 104 coupled to the twin-parallel turbocharger equipped engine 102. In one embodiment, the twin-parallel turbocharger equipped engine 102 may be a diesel engine.

The twin-parallel turbocharger equipped engine 102 may include a plurality of cylinders 106. In some embodiments, the twin-parallel turbocharger equipped engine 102 may include six cylinders 106 disposed in an in-line configuration. In other embodiments, the twin-parallel turbocharger equipped engine 102 may include more or less than six cylinders 106 disposed in any configuration, for example, a V-type configuration or a radial configuration, known in the art, without departing from the scope of the present disclosure.

The twin-parallel turbocharger equipped engine 102 may further include a pair of turbochargers 108 positioned in a parallel configuration. The pair of turbochargers 108 may be positioned in such a manner that a parallel flow of intake air or exhaust gases through the turbochargers 108 to or from the twin-parallel turbocharger equipped engine 102 may be ensured.

The pair of turbochargers 108 may individually be referred to as “turbocharger 108-1” and “turbocharger 108-2”. The turbocharger 108-1 may include a compressor 110-1 and a turbine 112-1 coupled to the compressor 110-1. Similarly, the turbocharger 108-2 may include a compressor 110-2 and a turbine 112-2 coupled to the compressor 110-2. In one embodiment, the compressor 110-1 and the compressor 110-2 may collectively be referred to as “compressors 110”. Similarly, the turbine 112-1 and the turbine 112-2 may collectively be referred to as “turbines 112”.

In one embodiment, intake air may enter the plurality of cylinders 106 through inlet passages 114, individually referred to as “inlet passage 114-1” and “inlet passage 114-2”. The inlet passage 114-1 may include, but is not limited to, the compressor 110-1 and a charge air cooler 116 disposed between the compressor 110-1 and the plurality of cylinders 106. Further, the inlet passage 114-2 may include, but is not limited to, the compressor 110-2 and the charge air cooler 116.

The charge air cooler 116 may be coupled to the plurality of cylinders 106 which may in turn be coupled to the turbines 112 through exhaust manifolds 107 and exhaust conduits 118. In particular, the plurality of cylinders 106 may be coupled to the turbine 112-1 and the turbine 112-2 of the turbocharger 108-1 and the turbocharger 108-2 through an exhaust manifold 107-1 and exhaust conduit 118-1 and an exhaust manifold 107-2 and exhaust conduit 118-2, respectively.

The turbines 112 of the turbochargers 108 may further be coupled to the dosing and mixing unit 104. The dosing and mixing unit 104 may include a mixer 120 and a hydrocarbon dosing unit 122 coupled to the mixer 120. As shown, exhaust outlets 124 of the turbines 112 of the twin-parallel turbocharger equipped engine 102 may be coupled to inlets 136 of the mixer 120. In one embodiment, the dosing and mixing unit 104 may form a part of an after-treatment system 126.

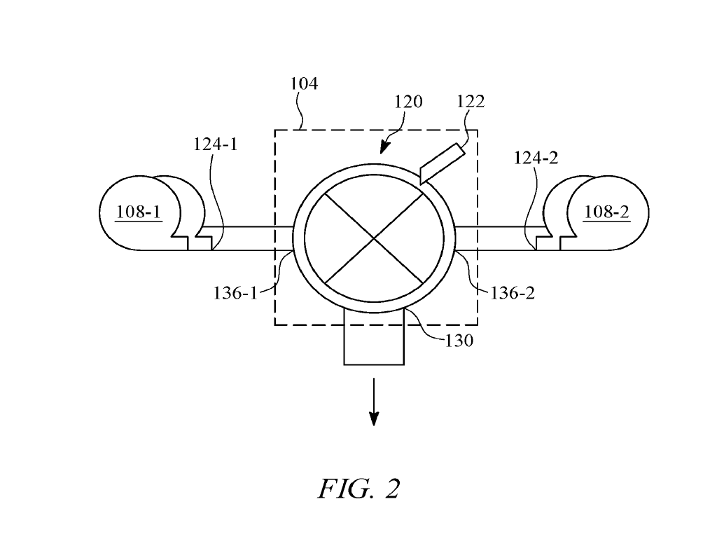

FIG. 2 illustrates an enlarged view of the turbochargers 108 and the dosing and mixing unit 104 of the compact hydrocarbon dosing and mixing system 100, according to one or more embodiments of the present disclosure. Referring to FIG. 1 and FIG. 2, the exhaust outlets 124 of the turbines 112 of the twin-parallel turbocharger equipped engine 102 may be combined into the mixer 120.

In particular, an exhaust outlet 124-1 and an exhaust outlet 124-2 of the turbine 112-1 and the turbine 112-2 may be coupled to an inlet 136-1 and an inlet 136-2 of the mixer 120, respectively. Therefore, the mixer 120 may be disposed in between the exhaust outlet 124-1 and the exhaust outlet 124-2 of the twin-parallel turbocharger equipped engine 102 for receiving exhaust gases from the turbine 112-1 and the turbine 112-2, respectively. In one embodiment, the mixer 120 may be a stationary mixer. In one embodiment, the mixer 120 may be a fixed geometry mixer. In one embodiment, the mixer 120 may be a single flower pot hydrocarbon mixer. In one embodiment, the mixer 120 may be one of a manifold-mounted mixer, a head-mounted mixer, and a block-mounted mixer.

Further, the hydrocarbon dosing unit 122 may be adapted to dose or inject hydrocarbons into the mixer 120. In one embodiment, the hydrocarbon dosing unit 122 may be a 7th injector hydrocarbon dosing unit.

Referring to FIG. 1, in one embodiment, the compact hydrocarbon dosing and mixing system 100 may include an oxidation catalyst 128 coupled to an outlet 130 of the mixer 120. In particular, the outlet 130 may be coupled to an inlet 132 of the oxidation catalyst 128. In other embodiments, the mixer 120 may be coupled to the oxidation catalyst 128 in various other configurations, without departing from the scope of the present disclosure. The oxidation catalyst 128 may include, but is not limited to, a diesel oxidation catalyst, an Ammonia Oxidation (AMOX) catalyst, a Selective Catalytic Reduction (SCR) device, a Three-Way Catalyst (TWC), and a Lean NO_{X} Trap (LNT).

In some embodiments, the compact hydrocarbon dosing and mixing system 100 may include the diesel oxidation catalyst 128 disposed downstream from the mixer 120. In one embodiment, the diesel oxidation catalyst 128 may be a component of the after-treatment system 126. In one embodiment, a distance between the outlet 130 of the mixer 120 and the inlet 132 of the diesel oxidation catalyst 128 may be predetermined such that the hydrocarbons dosed into the mixer 120 may evaporate before an exhaust stream output may enter the diesel oxidation catalyst 128.

In some embodiments, the compact hydrocarbon dosing and mixing system 100 may include a control circuitry 134. The control circuitry 134 may be in communication with the hydrocarbon dosing unit 122. In some embodiments, the control circuitry 134 may include a processor (not shown), an interface (not shown), and a memory (not shown) coupled to the processor. The processor may be configured to fetch and execute computer readable instructions stored in the memory. In some embodiments, the processor may be implemented as one or more microprocessors, microcomputers, microcontrollers, digital signal processors, central processing units, state machines, logic circuitries or any devices that manipulate signals based on operational instructions.

The interface may facilitate multiple communications within a wide variety of protocols and networks, including wired networks. Further, the interface may include a variety of software and hardware interfaces. In some implementations, the interface may include, but is not limited to, peripheral devices, such as an external memory. In one example, the interface may include one or more ports for connecting the control circuitry 134 to an output unit (not shown).

In some embodiments, the memory may include a non-transitory computer-readable medium. In one example, the non-transitory computer-readable medium may be a volatile memory, such as static random access memory and a non-volatile memory, such as read-only memory, erasable programmable ROM, and flash memory. The control circuitry 134 may include modules and data. The modules may include hardware and/or software (routines, programs, objects, components, and data structures) which perform particular tasks or implement particular data types.

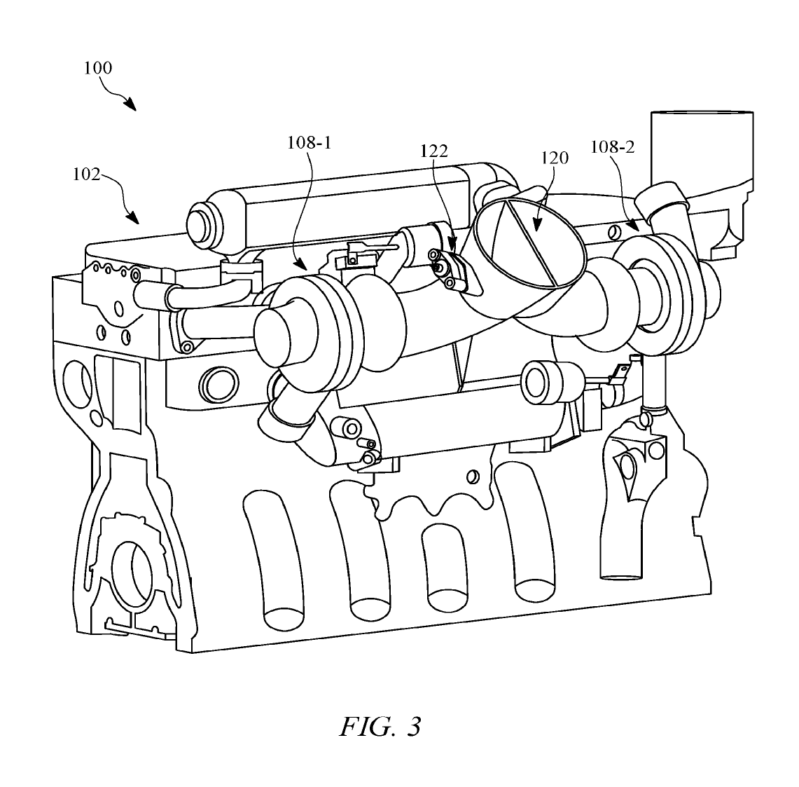

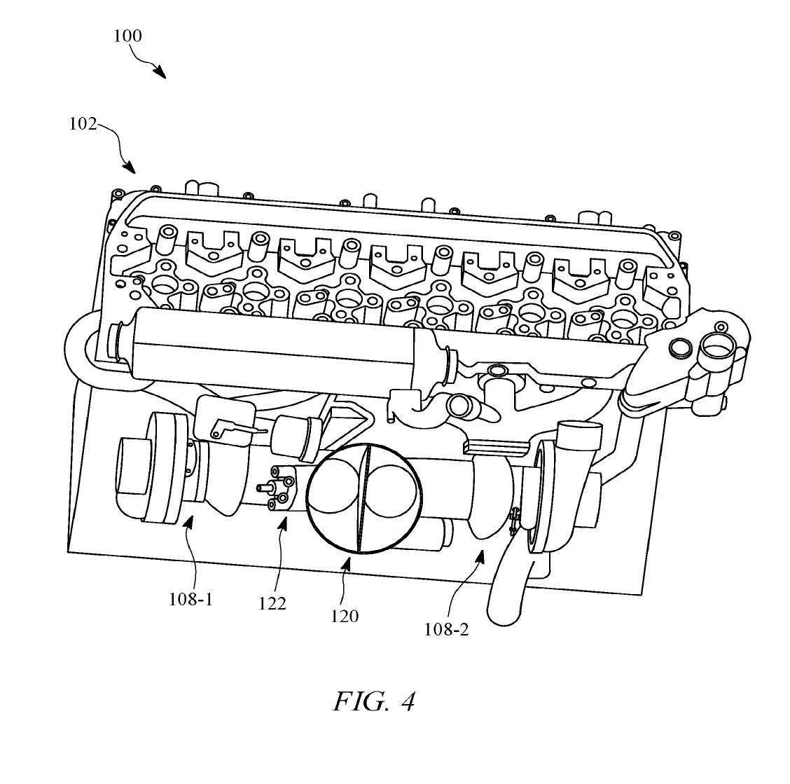

FIG. 3 illustrates a perspective view of the compact hydrocarbon dosing and mixing system 100 of FIG. 1, according to one or more embodiments of the present disclosure. As shown, the hydrocarbon dosing unit 122 may be integrated with the mixer 120, and the integrated configuration may then be positioned between the turbocharger 108-1 and the turbocharger 108-2. FIG. 4 illustrates a cross-sectional view of the compact hydrocarbon dosing and mixing system 100 of FIG. 1, according to one or more embodiments of the present disclosure.

Referring to FIG. 1, FIG. 2, FIG. 3, and FIG. 4, intake air may enter the twin-parallel turbocharger equipped engine 102 through the inlet passages 114. After entering the inlet passages 114, the intake air may be compressed by the compressors 110 before being fed to the charge air cooler 116. In one embodiment, the compressors 110 may increase a temperature and/or a pressure of the intake air.

Upon receiving the intake air from the compressors 110, the charge air cooler 116 may control a charge density and a flow rate of the intake air before allowing the intake air to flow towards the plurality of cylinders 106. In one embodiment, the charge air cooler 116 may decrease the temperature of the intake air. As a result, high-density low-temperature intake air may be obtained as an output of the charge air cooler 116.

In one embodiment, the inlet passages 114 may also include air cleaners (not shown) disposed upstream to the compressors 110, and throttle valves (not shown) disposed downstream to the charge air cooler 116. The air cleaners may be adapted to clean air before flowing to the compressors 110. Further, the throttle valves may control a flow rate of intake air flowing from the charge air cooler 116 towards the plurality of cylinders 106.

In one embodiment, the intake air received from the charge air cooler 116 may be inducted into combustion chambers (not shown) of the plurality of cylinders 106. After combustion, exhaust gases may leave the plurality of cylinders 106 through the exhaust manifolds 107 and exhaust conduits 118. The exhaust conduit 118-1 may carry the exhaust gases flowing from the plurality of cylinders 106 through exhaust manifold 107-1 towards the turbine 112-1 of the turbocharger 108-1. The exhaust conduit 118-2 may carry the exhaust gases flowing from the plurality of cylinders 106 through exhaust manifold 107-2 towards the turbine 112-2 of the turbocharger 108-2.

The exhaust gases may flow towards the turbines 112 to rotate the turbines 112. After rotating the turbines 112, the exhaust gases may flow through exhaust outlets 124 of the turbines 112 to the dosing and mixing unit 104. In one embodiment, the dosing and mixing unit 104 along with the diesel oxidation catalyst 128 may form the after-treatment system 126, and may treat the exhaust gases to meet emissions regulations.

In one embodiment, the mixer 120 of the dosing and mixing unit 104 may be adapted to mix the exhaust gases flowing from the turbines 112 with the hydrocarbons received from the hydrocarbon dosing unit 122, for evaporation of the hydrocarbons. The hydrocarbons may include, but are not limited to, unburnt hydrocarbons, which may be a reformate of the fuel used in the twin-parallel turbocharger equipped engine 102. In one embodiment, a reformer unit (not shown) may reform the hydrocarbons from the fuel to, for example, Hydrogen (H₂) and Carbon Monoxide (CO). In another embodiment, the hydrocarbon dosing unit 122 may obtain the hydrocarbons from a hydrocarbon storage source (not shown) for injection into the mixer 120.

Further, the diesel oxidation catalyst 128 may receive the exhaust stream output from the mixer 120. The diesel oxidation catalyst 128 may be adapted to catalyze oxidation of one or more compounds in the exhaust stream output. In one embodiment, the diesel oxidation catalyst 128 may oxidize, for example, unburned hydrocarbons and Nitric Oxide (NO) to Nitrogen Peroxide (NO₂).

In one embodiment, the after-treatment system 126 may also include a particulate matter filter (not shown) disposed downstream to the diesel oxidation catalyst 128. The particulate matter filter may be adapted to reduce a level of particulates in the exhaust gases by filtering the particulate matter. The particulate matter filter may include, but is not limited to, a Diesel Particulate Filter (DPF) and a Partial Flow particulate Filter (PFF).

In one embodiment, when the control circuitry 134 is configured to control operations of the hydrocarbon dosing unit 122, the control circuitry 134 may control parameters including, but not limited to, a rate and a quantity of the hydrocarbons to be dosed into the mixer 120.

In another embodiment, the control circuitry 134 may be configured to control operations of the dosing and mixing unit 104. Therefore, the control circuitry 134 may be in communication with the hydrocarbon dosing unit 122 and the mixer 120. In such an embodiment, the control circuitry 134 may control parameters including, but not limited to, the rate and the quantity of the hydrocarbons, and operational characteristics of the mixer 120.

In other embodiments, the control circuitry 134 may be configured to control operations of the compact hydrocarbon dosing and mixing system 100, without departing from the scope of the present disclosure. In such embodiments, the control circuitry 134 may be in communication with the turbochargers 108, the charge air cooler 116, the twin-parallel turbocharger equipped engine 102, the mixer 120, the hydrocarbon dosing unit 122, and the diesel oxidation catalyst 128.

In one embodiment, the control circuitry 134 may be in communication with one or more sensors (not shown) coupled with components of the compact hydrocarbon dosing and mixing system 100. The sensors may detect values of parameters pertaining to operation of the components of the compact hydrocarbon dosing and mixing system 100, and the control circuitry 134 may control the components based on the detected values.

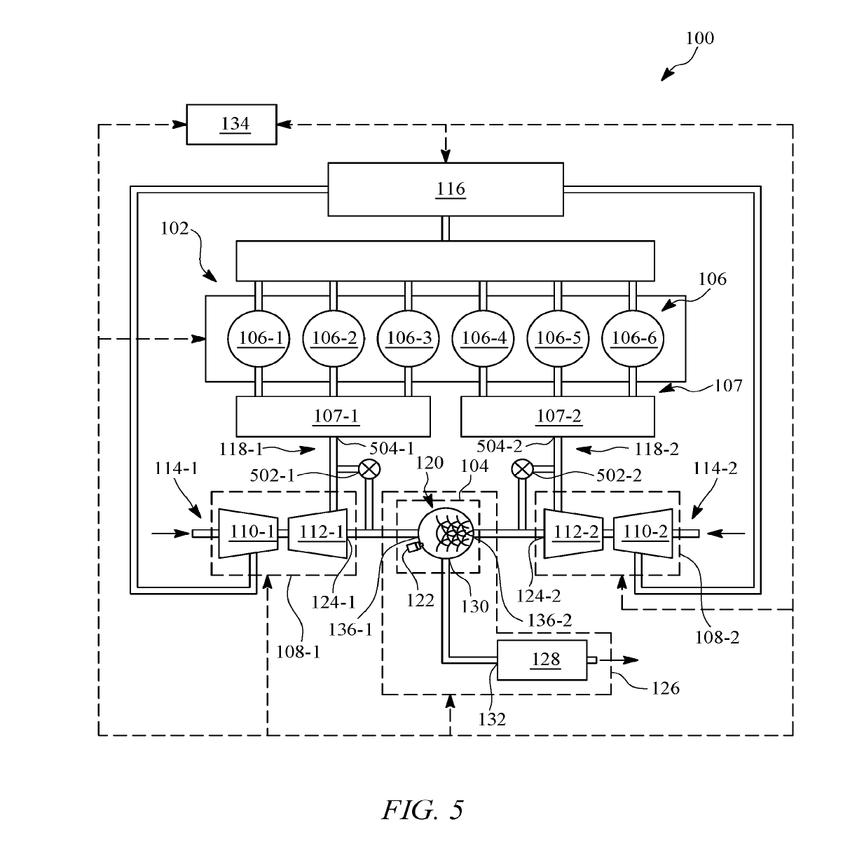

In one embodiment, the compact hydrocarbon dosing and mixing system 100 may include boost-controlled wastegates between the twin-parallel turbocharger equipped engine 102 and the mixer 120. In another embodiment, the compact hydrocarbon dosing and mixing system 100 may include electronic wastegates between the twin-parallel turbocharger equipped engine 102 and the mixer 120. FIG. 5 illustrates a schematic view of the compact hydrocarbon dosing and mixing system 100 having the electronic wastegates 502, according to one or more embodiments of the present disclosure.

The electronic wastegates 502 may be coupled, for example, between outlets 504 of the plurality of exhaust manifolds 107 and the inlets 136 of the mixer 120. In some embodiments, the compact hydrocarbon dosing and mixing system 100 may include a pair of electronic wastegates 502, individually referred to as “wastegate 502-1” and “wastegate 502-2”. Further, the outlets 504 of the exhaust manifolds 107 may individually be referred to as “outlet 504-1” and “outlet 504-2”. In some embodiments, the outlet 504-1 is shown as an outlet for exhaust manifold 107-1. Similarly, the outlet 504-2 is shown as an outlet for exhaust manifolds 107-2.

As shown, the wastegate 502-1 may be coupled to the exhaust conduit 118-1 between the outlet 504-1 and the inlet 136-1 of the mixer 120. Further, the wastegate 502-2 may be coupled to the exhaust conduit 118-2 between the outlet 504-2 and the inlet 136-2 of the mixer 120.

After combustion, the exhaust gases from the twin-parallel turbocharger equipped engine 102 may be delivered to the electronic wastegates 502 through the exhaust conduits 118. In one embodiment, the electronic wastegates 502 may be biased towards a close position by default. In one embodiment, when a flow rate of the exhaust gases is below a predefined threshold value for opening the electronic wastegates 502, the exhaust gases may flow through the turbines 112 of the turbochargers 108 before entering the mixer 120.

In another embodiment, when the flow rate of the exhaust gases is equal to or above the predefined threshold value for opening the electronic wastegates 502, the electronic wastegates 502 may allow the exhaust gases to bypass the turbines 112 and move directly towards the mixer 120. Further, in one embodiment, the electronic wastegates 502 may allow a specific portion of the exhaust gases to flow towards the turbines 112 and the remaining portion of the exhaust gases to bypass the turbines 112. In one example, a percentage of opening of the electronic wastegates 502 may vary the flow of the exhaust gases towards the turbines 112.

In one embodiment, the compact hydrocarbon dosing and mixing system 100 may include more or less than two electronic wastegates 502, without departing from the scope of the present disclosure. In one embodiment, the wastegate 502-1 and the wastegate 502-2 may operate independent of each other. Therefore, in one embodiment, one of the electronic wastegates 502 may allow the exhaust gases to pass through the corresponding turbine 112 whereas the other wastegate, for example, the wastegate 502-1 or the wastegate 502-2, may allow the exhaust gases to bypass the corresponding turbine 112, without departing from the scope of the disclosure.

In one embodiment, the control circuitry 134 may be configured to control the electronic wastegates 502. Therefore, the opening and closing of the electronic wastegates 502 for controlling the flow of the exhaust gases towards the turbines 112 may be controlled by the control circuitry 134.

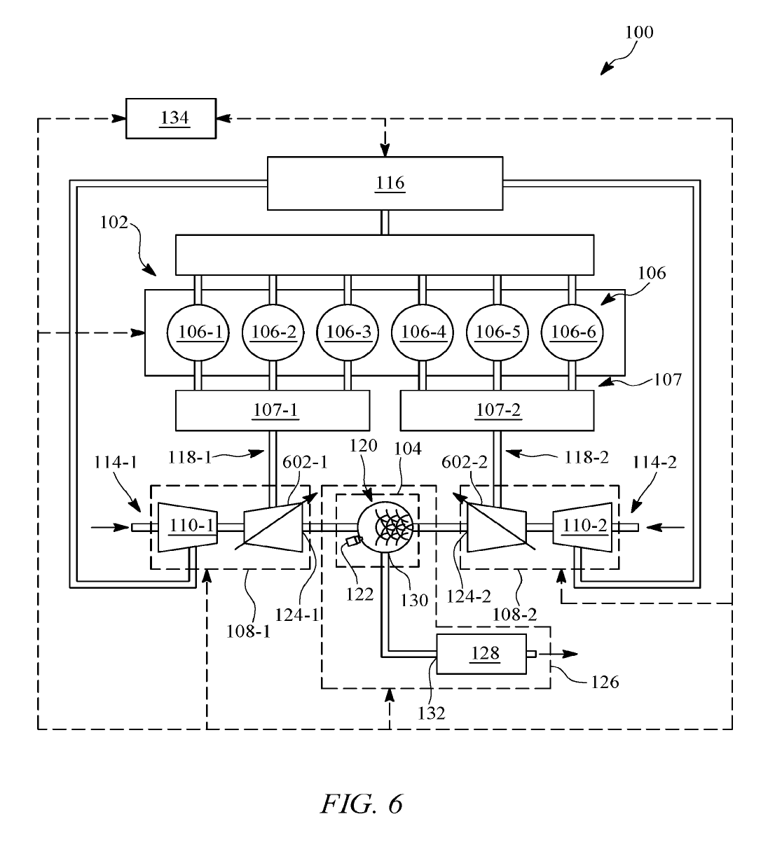

Further, in one embodiment, the turbines 112 of the turbochargers 108 of the compact hydrocarbon dosing and mixing system 100 may be of variable geometry, hereinafter referred to as variable geometry turbines 602. In such an embodiment, the compact hydrocarbon dosing and mixing system 100 may not include the electronic wastegates 502. FIG. 6 illustrates a schematic view of the compact hydrocarbon dosing and mixing system 100 having the variable geometry turbines 602, according to one or more embodiments of the present disclosure.

In some embodiments, the variable geometry turbines 602 may individually be referred to as variable geometry turbine 602-1 and variable geometry turbine 602-2. In one embodiment, the variable geometry turbine 602-1 and the variable geometry turbine 602-2 may be a part of the turbocharger 108-1 and the turbocharger 108-2, respectively.

Each of the variable geometry turbines 602 may include variable vanes (not shown) to control a flow of the exhaust gases towards turbine blades (not shown). Therefore, the variable vanes may be disposed upstream to the turbine blades. Upon entering the variable geometry turbines 602, the exhaust gases may come in contact with the variable vanes. The variable vanes may be movable, and may move in order to provide a passage (not shown) to the exhaust gases to flow towards the turbine blades. In one embodiment, an angle of movement of the variable vanes may determine a flow rate of the exhaust gases towards the turbine blades.

In one embodiment, the control circuitry 134 may control the variable vanes and therefore, the flow rate of the exhaust gases towards the turbine blades, by controlling the angle of movement.

### INDUSTRIAL APPLICABILITY

The present disclosure relates to the compact hydrocarbon dosing and mixing system 100 and a method 700 of manufacturing the compact hydrocarbon dosing and mixing system 100. In one embodiment, the compact hydrocarbon dosing and mixing system 100 may be implemented for a vehicle, such as a car, a truck, a bus, a boat, a recreational vehicle, and a locomotive. In other embodiments, the compact hydrocarbon dosing and mixing system 100 may be implemented for a non-vehicular application, such as a generator set, without departing from the scope of the present disclosure.

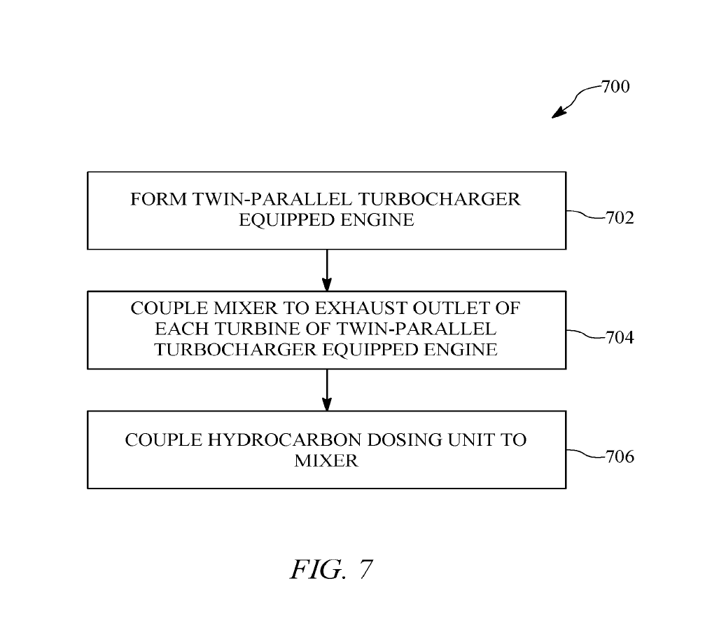

FIG. 7 illustrates a flowchart for the method 700 of manufacturing the compact hydrocarbon dosing and mixing system 100, according to one or more embodiments of the present disclosure. For the sake of brevity, the aspects of the present disclosure which are already explained in detail in the description of FIG. 1, FIG. 2, FIG. 3, FIG. 4, FIG. 5, and FIG. 6 are not explained in detail with regard to the description of the method 700.

At step 702, the method 700 may include forming the twin-parallel turbocharger equipped engine 102. As the name suggests, the twin-parallel turbocharger equipped engine 102 may include the pair of turbochargers 108 disposed in a parallel configuration.

At step 704, the method 700 may include coupling the mixer 120 to the exhaust outlets 124 of the turbines 112 of the twin-parallel turbocharger equipped engine 102. In some embodiments, the exhaust outlet 124-1 of the turbine 112-1 of the twin-parallel turbocharger equipped engine 102 may be coupled to the inlet 136-1 of the mixer 120. Further, the exhaust outlet 124-2 of the turbine 112-2 of the twin-parallel turbocharger equipped engine 102 may be coupled to the inlet 136-2 of the mixer 120.

At step 706, the method 700 may include coupling the hydrocarbon dosing unit 122 to the mixer 120. The hydrocarbon dosing unit 122 may be coupled in such a manner that the hydrocarbons can be injected into the mixer 120.

The compact hydrocarbon dosing and mixing system 100 and the method 700 of the present disclosure offer a short distance between the hydrocarbon dosing unit 122 and the diesel oxidation catalyst 128 while simultaneously ensuring evaporation of the hydrocarbons before the exhaust gases enter the diesel oxidation catalyst 128. The hydrocarbon dosing unit 122 may be integrated with the mixer 120 in order to minimize the distance between the hydrocarbon dosing unit 122 and the diesel oxidation catalyst 128. In particular, the hydrocarbon dosing unit 122 and the mixer 120 may be integrated between the turbines 112 coupled to the twin-parallel turbocharger equipped engine 102.

The integrated configuration of the hydrocarbon dosing unit 122 and the mixer 120 may ensure a larger volume, a greater surface area, and an increased mixing flow field potential for the hydrocarbons in the exhaust gases. Also, the mixing of the exhaust gases flowing from the turbocharger 108-1 and the turbocharger 108-2 in the mixer 120 ensures an inherent turbulence within the mixer 120. Therefore, the hydrocarbons may evaporate prior to engagement with the diesel oxidation catalyst 128. This would also ensure a compact size of the after-treatment system 126 and therefore, a compact size of the compact hydrocarbon dosing and mixing system 100.

Further, the addition of the electronic wastegates 502 to the compact hydrocarbon dosing and mixing system 100 would assist in controlling the flow of exhaust gases towards the turbines 112. This would in turn assist in controlling the flow of the exhaust gases from the turbines 112 towards the mixer 120. Furthermore, the addition of the variable geometry turbines 602 in place of the turbines 112 may ensure a controlled flow of the exhaust gases from the variable geometry turbines 602 towards the mixer 120. In effect, mixing of the hydrocarbons with the exhaust gases and the vaporization of the hydrocarbons may be controlled by controlling the flow of the exhaust gases towards the mixer 120.

Moreover, manufacturing, handling, transporting, and maintenance of the after-treatment system 126 and the compact hydrocarbon dosing and mixing system 100 may be convenient owing to the compact size. As a result, a reduction in an operational cost of the compact hydrocarbon dosing and mixing system 100 is achieved. Therefore, the present disclosure offers the compact hydrocarbon dosing and mixing system 100 and the method 700 of manufacturing the compact hydrocarbon dosing and mixing system 100 that are compact, simple, effective, economical, flexible, and time saving.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A system comprising:
a twin-parallel turbocharger equipped engine;
a mixer coupled to an exhaust outlet of each turbine of the twin-parallel turbocharger equipped engine; and
a hydrocarbon dosing unit coupled to the mixer.

2. The system of claim 1, wherein the hydrocarbon dosing unit doses hydrocarbons into the mixer.

3. The system of claim 1, further comprising:
a diesel oxidation catalyst that receives an exhaust stream output from the mixer.

4. The system of claim 1, further comprising:
electronic wastegates coupled between exhaust manifold outlets of the twin-parallel turbocharger equipped engine and the mixer, wherein the electronic wastegates are controlled by control circuitry.

5. The system of claim 1, wherein the twin-parallel turbocharger equipped engine includes variable geometry turbines.

6. The system of claim 3, wherein a distance between an outlet of the mixer and an inlet of the diesel oxidation catalyst is predetermined such that all dosed hydrocarbons evaporate prior to engagement with the diesel oxidation catalyst.

7. The system of claim 1, wherein the mixer is disposed between the exhaust outlets of the turbines of the twin-parallel turbocharger equipped engine.

8. The system of claim 1, wherein the exhaust outlets of the turbines of the twin-parallel turbocharger equipped engine are combined into the mixer.

9. The system of claim 1, wherein the hydrocarbon dosing unit is a 7th injector hydrocarbon dosing unit.

10. The system of claim 1, wherein the mixer is a single flower pot hydrocarbon mixer.

11. The system of claim 1, wherein the mixer is a stationary mixer.

12. A system comprising:
a twin-parallel turbocharger equipped engine;
a mixer coupled directly to an exhaust outlet of each turbine of the twin-parallel turbocharger equipped engine;
a hydrocarbon dosing unit coupled to the mixer;
a diesel oxidation catalyst that receives an exhaust stream output from the mixer; and
control circuitry that controls operations of the hydrocarbon dosing unit.

13. The system of claim 12, wherein the hydrocarbon dosing unit doses hydrocarbons into the mixer.

14. The system of claim 12, further comprising:
electronic wastegates coupled between exhaust manifold outlets of the twin-parallel turbocharger equipped engine and the mixer, wherein the electronic wastegates are controlled by the control circuitry.

15. The system of claim 12, wherein the twin-parallel turbocharger equipped engine includes variable geometry turbines.

16. The system of claim 12, wherein a distance between an outlet of the mixer and an inlet of the diesel oxidation catalyst is predetermined such that all dosed hydrocarbons evaporate prior to engagement with the diesel oxidation catalyst.

17. The system of claim 12, wherein the hydrocarbon dosing unit is a 7th injector hydrocarbon dosing unit.

18. The system of claim 12, wherein the mixer is a single flower pot hydrocarbon mixer.

19. The system of claim 12, wherein the mixer is a stationary mixer.

20. A method of manufacturing a system, the method comprising:
forming a twin-parallel turbocharger equipped engine;
coupling a mixer to an exhaust outlet of each turbine of the twin-parallel turbocharger equipped engine; and
coupling a hydrocarbon dosing unit to the mixer.
